(19) United States
(12) Patent Application Publication
(10) Pub. No.: US 2004/0175837 A1
(43) Pub. Date: Sep. 9, 2004

(54) Compact opto-fluidic chemical sensor

(76) Inventors: Ulrich Bonne, Hopkins, MN (US); Purnendu K. Dasgupta, Lubbock, TX (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/727,834

(22) Filed: Dec. 4, 2003

Related U.S. Application Data
(60) Provisional application No. 60/431,654, filed on Dec. 4, 2002.

(51) Int. Cl. G01N 21/00

(52) U.S. Cl. 436/164; 422/82.05; 422/82.11

(57) ABSTRACT

A sensor having a tubular optical cell or similar structure with a membrane wall. The wall may be permeable so that analyte can enter into the tube containing a reagent. Conversely, the wall structure could instead operate to let reagent enter into the tube containing the analyte. Attached to one end of the tube may be a reagent reservoir. A valve may be attached to the other end of the tube and to a reagent disposal container. The flow or replacement of the reagent in the tube may be caused by gravity, a pump, elastic reservoir design or pressurized gas. One or more light sources may be positioned at one end of the tube with a light detector at the other end. Processing and display electronics may be connected to the valve, light sources and detector.

This application claims priority under 35 U.S.C. §119(e)(1) to co-pending U.S. Provisional Patent Application No. 60/431,654, filed Dec. 4, 2002, and entitled “INTEGRATED WAVEGUIDE SENSORS”, wherein such document is incorporated herein by reference.

A related patent document includes U.S. Pat. No. 6,393,894 B1, issued on May 28, 2002, to Ulrich Bonne et al., and entitled “Gas Sensor with Phased Heaters for Increased Sensitivity”, which is hereby incorporated by reference in the present specification. Another related patent document includes U.S. Pat. No. 6,597,438 B1, issued on Jul. 22, 2003, to Cleopatra Cabuz et al., and entitled “Portable Flow Cytometry”, which is hereby incorporated by reference in the present specification. Another related patent document includes U.S. patent application Ser. No. 10/672,483, filed Sep. 26, 2003, by Ulrich Bonne, and entitled “Phased Micro Analyzer V, VI”, which is hereby incorporated by reference in the present specification.

### BACKGROUND

The present invention pertains to sensors and particularly to fluid sensors. More particularly, the invention pertains to a sensor having an optical method of measurement and structure.

There are many sensing needs for corrosive gases such as NO₂, Cl₂, H₂, S, CH₃SH, SO₂, and the like, toxic gases such as O₃, CO including those just listed, water pollutants such as Cl⁻, Na⁺, and species contributing to BOD and COD, and gases in condensing (two phase) environments as in PEMFCs (proton exchange membrane full cells). Such sensing cannot be met in a practical and affordable way by known and relatively conventional sensing methods. For instance, optical transmission methods in the gas phase are too bulky and not workable in condensing two-phase environments and are costly. Electrochemical methods have a short service life (e.g., electrode fouling) and are costly. Conventional water quality sensing instruments are also costly and bulky.

### SUMMARY

The invention may provide a solution to the shortcomings of the known, conventional sensors by adapting and expanding on an optical transmission change that may occur inside and along a narrow optical path. Such change may be precipitated by a reaction between the molecule to be detected (i.e., analyte) and an appropriate reagent and remembering that the rate of reaction may be dependent on the concentration of the analyte. The analyte and the reagent stream may meet and react as or after the analyte permeates through a membrane enclosing the optical path.

### BRIEF DESCRIPTION OF THE DRAWINGS

FIG. 1 is a diagram of a membrane fluid sensor;

FIG. 2 is a diagram of membrane sensor;

FIG. 3 is an absorbance versus time graph for an example sensor having various concentrations of NO₂;

FIG. 4 is a graph of the response of an example sensor subject to chlorine pulses of 100 ppb in concentration and of one minute duration;

FIG. 5 is a graph showing the effect of the sample flow rate on the response for various kinds of membranes;

FIG. 6 is a graph of a tubular sensor response to a pulse of chlorine;

FIG. 7 is a graph showing light throughput relative to a percentage of matrix modifier to lower evaporative loss of reagent, for several membranes at different wavelengths;

FIG. 8 is a bar graph of light throughput for different membrane tubes with water and with a matrix modifier;

FIG. 9 is a graph of absorbance versus time for a membrane having different concentrations of ozone;

FIG. 10a is graph of ion chromatography measurements of HONO along with simultaneous measurements of NO₂ by a gas phase CL based Federal Reference Method (FRM) NO₂ instrument;

FIGS. 10a and 10c are graphs showing ozone absorbance versus time for various amounts of ozone, without and with a dye added to the reagent, respectively.

FIG. 11 shows the absorbance signal versus time for various operational modes of the sensor; and

FIG. 12 shows a display for results of the sensor's processing electronics.

### DESCRIPTION

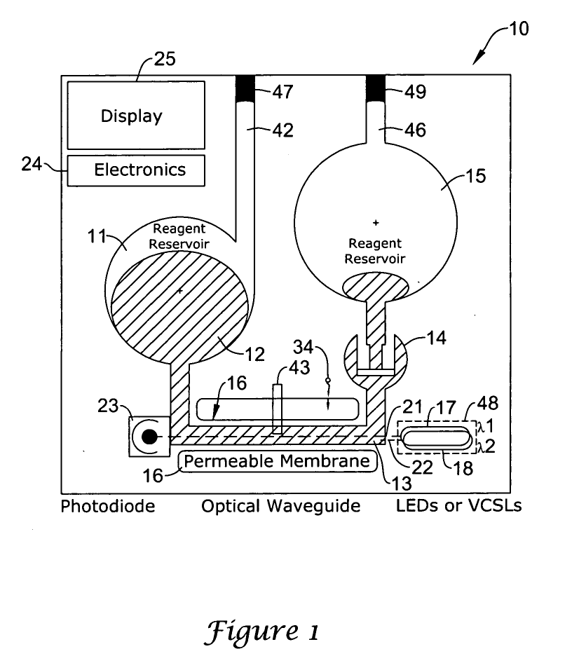

The sensing approach of the present invention may be based on filling an optical channel or waveguide 13 with a gas-specific, chromogenic reagent 12 as indicated in FIG. 1. Calibration of a gas concentration may be performed by a rate of observed change in optical transmission. This technology may provide new dimensions in sensing. The optical transmission of gases reacting with a condensed phase (i.e., a liquid reagent 12) may improve sensitivity, as well as selectivity, versatility and affordability, while reagent 12 may remain encapsulated inside of its hydrophobic fiber or tube 16. This approach can result in clean, leak-free and safe device operation. Present device 10 may achieve sensing concentrations of aggressive gases which may be either not possible with gas chromatography (such as of NO₂, O₃, Cl₂, HF, and the like, which can react with any known column material) or not compact and affordable optical gas-phase absorption devices. The shortcomings of presently available technologies is illustrated by the following points: 1) The path length of tube 16 needed to detect 10 ppb of O₃ may be about a costly 100 cm.; 2) Optical detection of 1-10 ppm of CO may also require approximately 100 cm paths, unless the infrared (IR) spectral resolution is reduced to about one nm or natural line-width level, which may cause great cost and a poor S/N ratio; and 3) NDIR CO₂ measurements may be hindered by water-vapor interferences.

Device 10 may provide a simpler approach. Manufacturing costs of device 10 may be lower than that of an NDIR CO₂ sensor because low-cost visible LED light sources 17 and 18 and Si photodiodes 23 may be used, although other kinds of light sources (e.g. VCSELs) and detectors may be used, and enable a low cost sensor because the present device may be miniaturized and assembled at a Si or polymer-wafer level. Device 10 may sense gases in dry or wet (condensing) environments or even in a solution, as needed for water quality control and fuel cell control.

Device 10 may readily measure ambient levels of NO₂ and O₃. Other fluids that may be measured by the present device are CO, Cl₂, and SO₂. Virtually any gas that can be measured by selective chromogenic reactions may be measured after an appropriate chemistry adaption of device 10.

Device 10 may offer single digit ppb minimum detection limits of NO₂ and O₃ within 5 to 10 minutes or less if the optical fiber diameter is smaller or of higher permeability. Device 10 may provide unattended operation for a day or a week with good precision (i.e., 2 to 5 percent RSD (relative standard 15 deviation). Longer operational times with such precision may be possible with reversible reagents, such as those based of chromogenic pH changes induced by, for example, CO₂. This device may be readily adapted for measuring a different gas, as indicated by the list of gases shown in the following table.

| | | |
|---|---|---|
| Ozone | Reaction with | This may be a standard |
| | indigotrisulfonate (ITS). | method of measuring ozone |
| | The dye may be bleached, | in water and may have been |
| | accompanied also by | demonstrated for use in |
| | chemiluminescence (CL). | measuring gaseous ozone. |
| | Maximum absorption at 605 nm. | |
| Nitrogen dioxide | Reaction with Griess- | May be calibrated with |
| | Saltzman (G-S) reagent | aqueous nitrite. Direct |
| | (naphthylethylenediamine and | collection should not |
| | sulfanilic | result in stoichiometric |
| | acid/sulfanilamide in dilute | conversion of NO₂ to |
| | acetic acid). Several | nitrite. One EPA |
| | alternative newer reagent | procedure may use reducing |
| | formulations may exist. | agents/triethanolamine to |
| | Maximum absorption at 480-550 nm | first collect and then |
| | depending on | react with G-S reagent. |
| | chemistry. | Gas may be collected in |
| | | the polymer to be |
| | | delivered to the reagent. |
| | | Specific except |
| | | sensitivity to HONO as |
| | | HONO reacts. |
| Carbon monoxide | Reaction of low | Methods may be selective |
| | concentrations of silver p- | and readily applicable to |
| | sulfoaminobenzoate or | urban ambient |
| | potassium | concentrations of CO. |
| | tetrachloropalladate to | |
| | generate a sol. Broadband | |
| | absorption centered at 400 nm. | |
| Carbon dioxide | Phenol red buffered by 10 mM | Reversible. |
| | NaHCO₃. | |
| Sulfur dioxide | Reaction with blue Fe (III)- | Ozone may interfere. |
| | o-ohenanthroline to produce | Relative to conductometric |
| | orange Fe(II) -o- | measurement, ammonia may |
| | ohenanthroline. Decrease at | interfere and may be |
| | 600 nm or increase at 520 nm. | eliminated by using an |
| | Conductometric measurement | anion exchange membrane. |
| | may be followed by capture | In a tubular setup, a |
| | with slightly acidic dilute | bifilar wire electrode may |
| | H₂O₂ or HCHO. | run down the length of the |
| | | tube. |
| Chlorine | Reaction with o-tolidine or | Very selective, highly |
| | tetramethylbenzidine (non | selective. Low ppb levels |
| | carcinogenic) form yellow | easily determined. |
| | product monitored at 450 nm. | |
| Hydrogen sulfide | Reaction with micromolar | Sub-ppb levels may be |
| | concentrations of | easily measured. |
| | metallofluorescein | Mercaptans may also react. |
| | derivatives. Fluorescence | Differential measurement |
| | elicited by a blue LED may | may be possible using |
| | be quenched. | different membranes. |
| Cl₃C₂H₃ | Fujiwara ™ reagent for | Trichloroethylene-in-water |
| | hogenated HC's. | detection. |

The total instrument size of device 10, after suitable integration and packaging design, may be in a range between a typical business card (for personal monitors) and a paperback book (for a fixed location deployment such as, for example, NeSSi). Device may include in its structure, besides silicon, glass, ceramic and polymeric materials, for monolithic and hybrid sensor designs.

Device 10 may be incorporated in a micro flow cytometer used for blood analysis. It may be a multi-layer polymer card (business card-size) which stores a reagent for lysing the blood cells, controls flow (with microsensors) and steers individual cells towards an optical beam for their analysis. As a microfabricated O₃ and/or NO₂ monitor, device 10 may be designed as a business-card-sized monitor designed to hold a reagent 12 in a slightly pressured reservoir 11, from which reagent 12 is metered with an embedded flow sensor 43 into an optical path 13 as needed and then moved into a waste reservoir 15. A light source module 48 might or might not be a part of a disposable and sealed reagent “card”. Permeable membrane 16 may be designed to favor permeation of analyte 34 into the reagent tube 16 rather than let reagent 12 or its solvent escape into reagent tube 16 rather than let the reagent 12 or its solvent escape into the analyte environment. A cytometer is disclosed in U.S. Pat. No. 6,597,438 B1, issued on Jul. 22, 2003, to Cleopatra Cabuz et al., and entitled “Portable Flow Cytometry”, which is herein incorporated by reference.

Device 10 may be incorporated into a phased heater sensor. Device 10, as incorporated with the phased heater sensor, may be a chip design. The phased heater design may involve the integration of a flow sensor, a differential thermal conductivity sensor, a multi-stage preconcentration stage and a separator stage for analyte separation on a chip. A phased heater sensor is disclosed in U.S. Pat. No. 6,393,894 B1, issued on May 28, 2002, to Ulrich Bonne et al., and entitled “Gas Sensor with Phased Heaters for Increased Sensitivity”, which is herein incorporated by reference.

Device 10 may involve integrated air or water quality monitor functions to achieve reduced reagent use, size, and cost, and longer service life and greater flexibility. It may be integrated on a “card” with optics, fluidic controls, electronics and a communications module. Device may be used for the measurement of a gas such as CO in a high humidity, two-phase environment such as encountered in a proton exchange membrane fuel cell (PEMFC). Another application of device 10 may include the measurement of analyte 34 (such as water pollated with organic molecules that determine its COD of BOD value, or a useful surrogate of it) flowing inside of an optical path 13, while reagent 12 diffuses or permeates from the outside (where it is stored) to the inside, rather than in the opposite direction as indicated in FIG. 1. The larger COD/BOD active molecules typically cannot diffuse through the membrane wall. Provisions such as polarity, pressure differences (mechanical, chemical or osmotic) or hydrophobicity of the membrane may be used to minimize the permeation of the analyte solvent.

Still another application may be measurement with the reagent 12 and/or analyte 34 flowing steadily inside waveguide 13 integrated into tube 16 to establish an instantaneous indication of analyte 34 concentration based on the quasi steady-state level of optical transmission, rather than a batch-wise advance of liquid in the waveguide to enable a dosimetry approach to the measurement.

Also, device 10 may have the reagent-wetted part, i.e., containing a source reservoir 11, optical path 13 and waste reservoir 15, regarded as disposable, while light sources 17 and 18, optical detector 23, valve 14 and flow sensor 43 or like sensors, electronics 24 and other items on a block may be regarded as non-disposable.

The microfabrication of device 10, relative to conventional fabrication may result in reduced size, reduced cost via the wafer-level assembly or printing of low-cost multiplayer polymer cards, reduced reagent use and cost due to smaller volumes. This may be for easier servicing and/or reagent replacement. The lower cost of parts may result in greater flexibility in the choice of permanent disposable (or recyclable) parts of device or monitor 10. There may be longer times between reagent 12 replacements. For instance, a smaller inside diameter of an optical transmission cell may result in a lower rate of reagent use, despite equal cell sensitivity (i.e., the equal rate of molecular reaction in the optical path cross section). There may be easier commercialization of device 10 due to lower design, tooling and manufacture of microsensors.

FIG. 1 illustrates device 10 incorporating pressurized reservoir 11 which may provide reagent 12 to an optical channel 13 as needed via a valve 14 control. Valve 14 may open as a nee for fresh reagent 12 occurs. The old reagent 12 is let into a reagent container 15. Optical channel 13 may be formed with a permeable membrane 16 which contains reagent 12 and permits certain molecules of an ambient fluid to penetrate and enter optical channel 13 containing reagent 12.

Positioned at one end of channel 13 are a first light source 17 and a second light source 18. Light source 17 may emanate a light 21 of a first wavelength and light source 18 may emanate light 22 of a second wavelength. Light waves 21 and 22 may travel through reagent possibly containing molecules that have come through permeable membrane 16 and mixed in with reagent 12 in channel 13. Light 21 and light 22, after traveling through channel 13 to another end, impinge a photodiode 23. Electronics 24 may be connected to valve 14, light sources 17 and 18, and photodiode 23. Electronics 24 may control the flow of reagent 12 through channel 13 via valve 14. The emanation of light 21 and light 22 may be controlled by electronics 24 via its connection to light sources 21 and 22. Signals of photodiode 23, due to the receipt of light 21 and light 22, may be processed by electronics 24, in conjunction with control signals sent to valve 14, to result in signals that may provide information about the molecules permeating membrane 16 into channel 13. A display 25 may be connected to electronics 24 for receiving resultant signals. Display 25 may show the information of the resultant signals. These signals may be passed on to other devices or stations for various reasons that relate to a use of information about the permeating molecules.

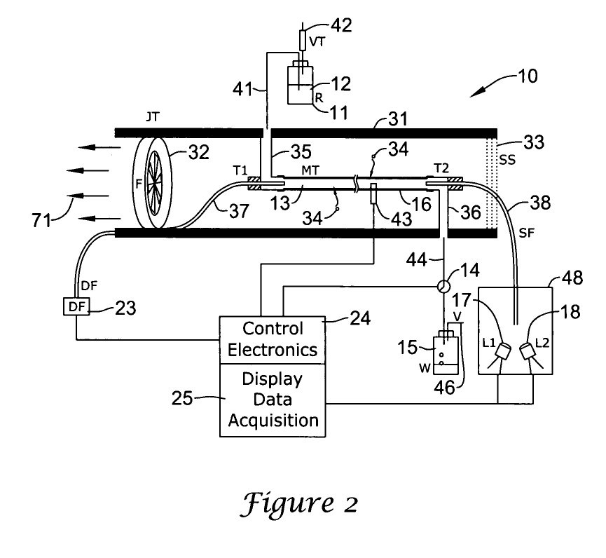

FIG. 2 is a more detailed illustration and application of the invention as shown by device 10. A sensor housing 31 may consist of an opaque jacket tubing. Housing 31 may have an inside diameter of about 35 mm and be molded from a polyethylene material. Housing 31 may have its inside surface lined with a poly (tetrafluoroethylene) (PTFE) liner. One end of housing 31 may be fitted with a fan 32. Fan 32 may pull a fluid 71, such as air, through housing 31. Fan 32 may have a 25 mm×25 mm cross section and fit in a molded left terminal end in housing 31. At the right terminal end in housing 31 may be a PTFE support screen 33.

At the center of device 10 may be a thin-walled membrane tube 16 suspended between two terminal tee tubes 35 and 36. Each tee tube, 35 and 36, may have a plastic or glass optical fiber, 37 and 38, respectively, inserted axially in it to be inside membrane tube 16. The internal diameter of membrane tube 16 may be approximately from 0.6 mm to 0.75 mm. Source acrylic optical fiber 38 and detector acrylic optical fiber 37 may have a diameter from about 0.4 mm to 0.5 mm. The vertical arm or opening of tee tube 35 may be connected to a reagent reservoir 11 via a tube 41. Reservoir 11 may be an impermeable light-tight container such as a dark glass bottle or one made from opaque thick-walled plastic. Reservoir 11 may be open to air via a vent trap 42. The vertical arm or opening of tee tube 36 may be connected to a waste container 15 via a tube 44 and a solenoid valve 14. A vent 46 may open waste container 15 to the ambient environment. Reservoir 11 may be placed higher in elevation than waste container 15 such that when valve 14 is opened, a gravity induced flow of reagent liquid 12 may occur through membrane tube 16. One or both vent traps 42 and 46 may be sealed with plugs 47 and 49, respectively, in certain configurations where reagent 12 is to be contained in sensor 10, particularly if implemented on a small card or in a cartridge. If vent 47 is sealed, reagent reservoir 11 may be pressurized for delivery of reagent to tube 16.

Tube 16 may allow ready transport of analyte gases through the wall of tube 16. The reagent chemistry may be chosen such that a reaction of the gas with reagent 12 in tube 16 results in a proportionate change in light absorption. This reaction may be virtually specific for the analyte gas of interest. Optical fibers 38 and 37 may bring light in and out of membrane tube 16. The other end of fiber 37 may be connected to a light detector 23. The other end of fiber 38 may be connected to a light detector 48. Tube 16 may behave as a long path light absorption cell. In many circumstances, a significant path length might not be possible because of a rapid loss of light to the walls of tube 16. There may be a particular combination of the polymer of which membrane tube 16 is constituted and the optical properties of the reagent contained in tube 24.

An analytical reaction of interest may result in either formation of color, e.g., when a Griess-Saltzman reagent reacts with NO₂ to form a purple azo dye or loss of color, as may happen with selective bleaching of indigo derivatives by ozone. The change of optical absorption of the device with continued exposure cannot continue indefinitely. For example, in the ozone-sensing example given above, there would be no indigo after a certain amount of disclosure. Similarly, in the NO₂ sensing example, with continued increase in the absorbance of the cell, there may be a point where too little light will reach detector 23, causing increased noise, or there may be a loss of linearity in the concentration-absorbance relationship due to the finite bandwidth of the light source, or both. Control electronics 24 may be programmed with an upper or lower absorbance limit (depending on whether analyte exposure results in increased or decreased light absorption). When this absorbance is reached, solenoid valve 14 may be energized for a preset period of time sufficient for the existing solution of reagent 12 to be flushed out of tube 16 and to be filled with a new reagent solution 12. Alternatively, refilling may be programmed to occur at fixed intervals of time, e.g., every 2 hours. Yet another alternative would be an approach involving a combination, e.g., refilling occurs when a preset absorbance limit is reached or when a preset interval is reached, which ever is first. The refill time may be of the order of 15 seconds. The system would tend not to collect data for about one minute following the refill period.

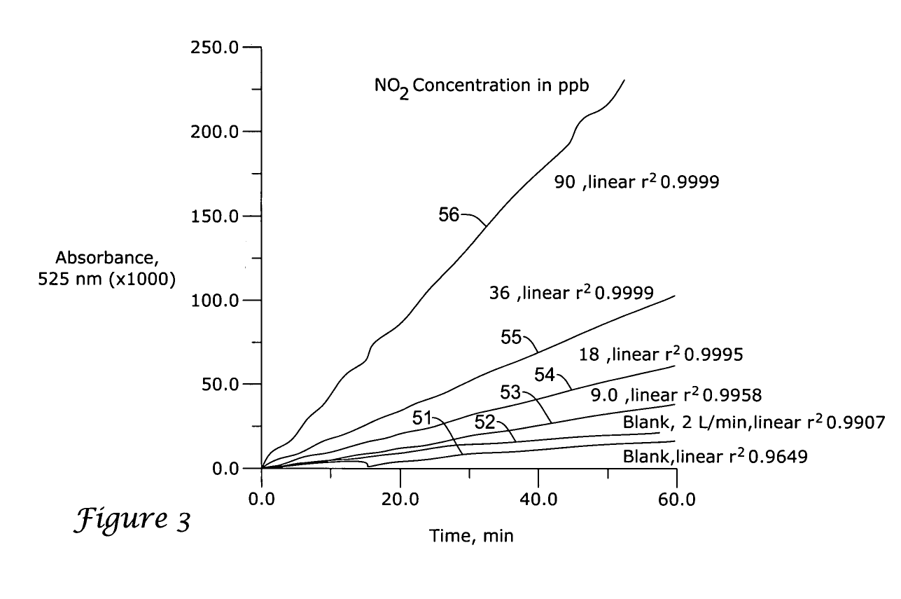

FIG. 3 shows a graph of the response of device 10 to different concentrations of NO₂ (ranging from 9 to 90 ppbv) for a Teflon® AF tube 16 having a 5.5 inch length, 0.031 inch inside diameter and a 0.005 inch wall, filled with a Griess-Saltzman reagent 12. In FIG. 3, it may be noted that at each concentration, the absorbance-time relationship appears to be a straight line (the linear r² values are also indicated and seem excellent). Further, the insets appear to show that the slopes of these lines 51, 52, 53, 54, 55 and 56 (i.e., rates of change of absorbance with time, dA/dt) are linearly related to the sampled concentration.

Device 10 may be intrinsically cumulative and the detection limit generally controlled by the integration time (or time interval) over which one may try to sense a change in absorbance. This is not tied in with the data acquisition rate. Unlike most available instruments, the integration time with device 10 may be essentially infinitely variable and not a constant determined by setting on the hardware. If the hardware performance limits dictate a minimum detectable absorbance change of ΔA, one may increase the internal Δt until the absorbance change over that interval at least equals ΔA. The observed slope ΔA/Δt may then be translated, based on the calibrated linear relationship of the slope with sampled concentration, to a concentration value which then has the effective integration time of Δt. The ultimate limitation of this approach is the blank response with time. For example, the reagent may represent a finite absorption. Even in the absence of analyte gas in the air sample, as reagent evaporation occurs, the reagent may get “concentrated” and the observed absorbance will increase. This phenomenon is shown in FIG. 3. The lowest two traces 51 and 52 represent blanks from dry air not containing NO₂. Trace 51 was obtained at the same flow rate as the samples (200 sccm) and as indicated, trace 52 was obtained at ten times that flow rate to exaggerate the effects of evaporation. It appears that 5 ppb would be easily detectable over an integration time of ten minutes. The primary limitation in these data is inadequate referencing which may lead to small shifts in the absorbance traces that are observable.

Device 10 may solve the above-noted problem by using two LEDs 17 and 18 at two different wavelengths. LEDs 17 and 18 may be coupled to the same light source optical fiber 38. One of the LEDs, LED 17, may emit light at a first wavelength at or near where the reaction product absorbs maximally. Another LED, say LED 18, may emit light at a second wavelength, i.e., a reference wavelength, where the absorption product does not absorb, or at least not maximally. In the NO₂ case, as an illustrative example, the first and second wavelengths may be 545 nm (green) and 780 nm (near infrared), respectively, which are alternatively pulsed on. Not only may such referencing eliminate noise/shifts that are vibrationally/structurally induced, it may also reduce or eliminate the effects of reagent evaporation. Reagent evaporation may increase the background absorbance but this may not necessarily have the same absorption spectrum as the analytical product. Further, evaporative concentration may also change (e.g., increase) the refractive index of the liquid in tube 16 which tends to increase the light throughput in a wavelength-independent manner. Second, wavelength referencing may solve these problems. Reagent evaporation may also be greatly minimized by the use of matrix modifiers (described below).

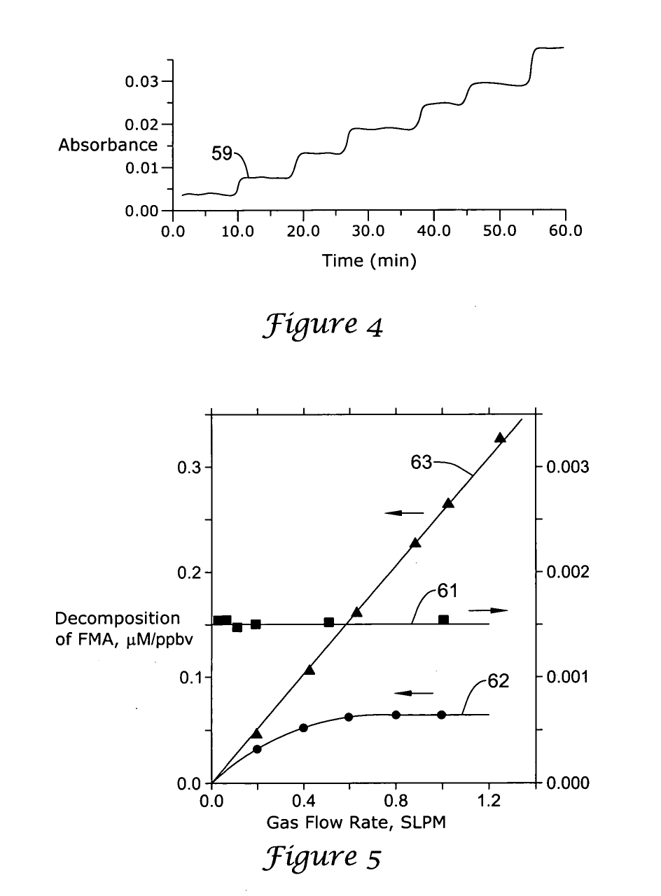

The behavior or such systems may be further illustrated also in a situation where device 10 is exposed to the analyte gas in a manner where the concentration does not remain constant with time but varies substantially. FIG. 4 shows the results of an experiment in which a tube similar to tube 16 is used. Such tube may have a 0.011 inch inside diameter, a 0.005 inch thick wall and a 6 inch length. This tube may be filled with a reagent that turns yellow upon exposure to chlorine and the reagent absorbance may be monitored by transmission of light from a blue LED. In such system, the device may be exposed largely to a flow of clean air except periodically it may be exposed to pulses of 100 ppb chlorine of one minute duration. A staircase pattern 59 may result as shown in FIG. 4. The absorbance is shown to go up only when exposed to chlorine and may remain unchanged otherwise. This graph illustrates an underlying principle that, while the difference in absorbance between two time points is proportional to the cumulative exposure (e.g., in ppb.min) in that time interval, the rate of change of absorbance, i.e., the slope of the plot at any point in time, is proportional to the instantaneous concentration. One may note that on the steps of plot 59, when the membrane tube of the device is exposed to air, the slope is zero. It is only between the steps that the slope is non-zero and appears in fact to be the same each time.

Tube 16 may be an optical waveguide. Tube 16 of device 10 may be made from Teflon® AF, as noted above, which is an amorphous highly gas permeable polymer, that also has a refractive index lower than that of water, such that tubes of this material filled with water or aqueous solutions behave as liquid core waveguides, permitting long path lengths with good light throughout. Thin wall tube 16 is generally essential for making a sensitive device 10. A custom extruded Teflon® AF tube 16 may have a 50 micron wall thickness

Tube 16 of device 10 may be a diffusive collector which generally follows a pattern where the flow rate is very dependent on the collection efficiency of the membrane. FIG. 5 shows the effect of sample gas flow rate on the response. More specifically, the figure shows the response per unit of concentration as a function of flow rate for three different types of membranes, 61, 62 and 63 for the detection of H₂S. Membrane 61 appears to have very poor collection efficiency and as such has almost no flow rate dependence (until one gets very close to no flow). Membrane 62 may be the generic response of diffusive collectors where the response initially increases linearly with flow rate and then becomes essentially independent of flow rate. Membrane 63 may depict a situation of a highly efficient membrane where response increases linearly with flow rate. Membranes 61 and 63 may be special cases of membrane 62. The linear rise region appears very small for membrane 61 and the plateau region has not yet been attained for membrane 63. For membrane tubes 16 used to generate FIGS. 3 and 4, the plateau region may be reached by 100 sccm. Whenever possible, the membrane should operate in the plateau region, because (unlike most other trace gas measurement instrumentation) accurate flow control should no longer be necessary. The ordinate of FIG. 5 is the ratio of the FMA decomposition in μM per ppb H₂S. For silicon membrane 61, with an 87 cm length and 82 ppbv H₂S, the right side ordinate scale applies. For a Nafion® (perfluorosulfonate ionomer) membrane 62, with a 70 cm length and 11 ppbv H₂S, and an ePTFE tube filament filled membrane 63, with a 60 cm length and 5.5 ppbv HₛS, the left side ordinate scale applies.

The mass transport rate through the membrane of tube 16 may be inversely related to the thickness of the membrane. As such, within the limits of manufacturability and fragility, a thinner membrane may result in a more sensitive device 10. For very thin membranes, one may have to utilize the internal referencing technique (two wavelength approach with light sources 17 and 18) for good results because vibrational noise could become an important factor relative to detection.

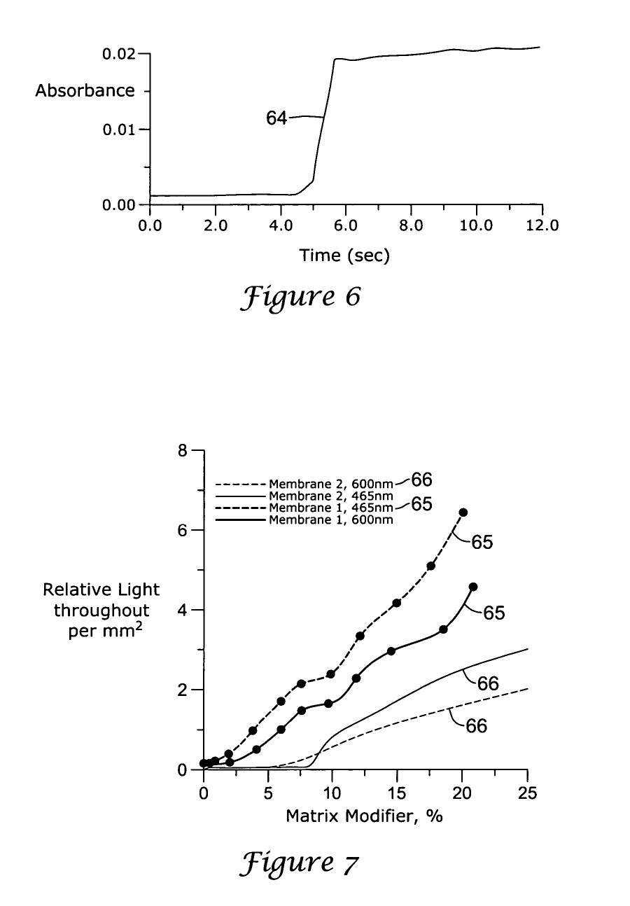

The thickness of the membrane may determine the shortest achievable time lag time and response time, as well as the achievable minimum detection limit. Thus, a practical monitor or device 10 design may be based on the membrane thickness that leads to the most appealing compromise between detection limit and reagent use rate. FIG. 6 shows the response of an ultra thin membrane tube 16 to a pulse of chlorine. More specifically, it is a graph curve 64 showing the absorbance response of an 18 micron thick tubular sensor to a 100 msec pulse of chlorine using the same chemistry of FIG. 4, i.e., a diffusion-controlled reaction.

The membrane may also double as an absorption cell. The absorbance may linearly increase with path length (as long as one is operating in the plateau response region in the gas flow rate as for membrane 62 of FIG. 5). However, sensitivity and the limit of detection (LOD) are not synonymous. In practice, the best LOD may be obtained at an optimum cell length dictated by the maximum absorbance during a measurement cycle. Beyond this, the measurement noise may deteriorate the attainable LOD despite an increase in sensitivity.

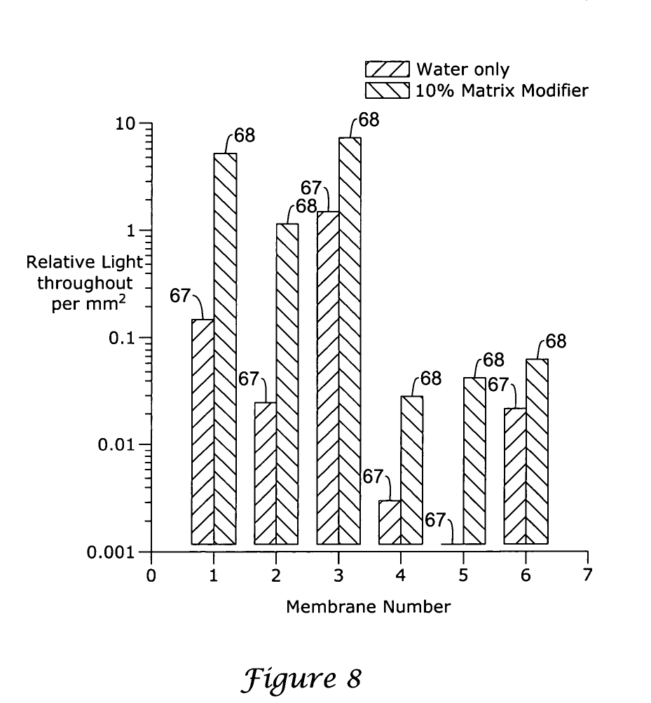

An important factor is the light conducting of the membrane, which in turn is a function of the optical properties of the membrane and the reagent liquid. In this respect, a combination of Teflon® AF and virtually any liquid may excel. However, the combination of certain inert matrix modifiers (10-20 percent by volume of the reagent) and certain membrane materials may equal or exceed the light transmission characteristics of a water-filled Teflon® AF tube 16. In this context, the matrix modifiers may significantly lower evaporative loss of the reagent. FIG. 7 is a graph that reveals an increase in light throughput with a matrix modifier. The graph shows the percentage of matrix modifier in the abscissa versus the relative light throughput per square millimeter in the ordinate axis. Dashed line 65 with the dots relates to a membrane 65 at a 465 nm wavelength of light. Solid line 65 with the dots relates to a membrane 65 at a 600 nm wavelength of light. Dashed line 66 relates to a membrane 66 at a 465 nm wavelength of light. Solid line 66 relates to a membrane 66 at a 600 nm wavelength of light. One may note an opposite wavelength dependence of membranes 65 and 66 relative to the light throughput as it may be affected by the amount of matrix modifier.

FIG. 8 shows a graph of relative light throughput per unit cross section (mm²) for different membrane tubes of comparable length for water with ten percent of a matrix modifier and for water only. One may note, for example, that tube 16 with membrane number one and water with ten percent of matrix modifier has a greater light throughput than tube 16 with membrane number three. Water only bars are designed as 67 and ten percent of a matrix modifier bars are designated as 68. It appears that a ten percent matrix modifier improves light throughput of the respective membrane numbers for various tubes 16.

The higher the light transmission, the optimum cell length may be longer. A typical value may be in a range from 2 to 20 cm. The internal diameter of tube 16 may increase the surface-to-volume ratio and promote increased sensitivity. Also, liquid phase diffusion may be slow. If too large of a diameter is used for tube 16, then the effects of the analyte gas may be limited to the interior wall region and not proceed to the center of tube 16. However, too small of a diameter may lead to more noise because of a decreased light throughput. Tube 16 having a diameter from about 0.5 mm to 1.0 mm may be most practical.

Membranes may be divided into two groups—porous and permeative. In dealing exclusively with aqueous solutions as reagents, the porous membranes used may be composed of a hydrophobic matrix such as PTFE or polyprophylene or the like. Porous membranes may offer high collection efficiency. But if the pores are too small, deposits from evaporation or deposition from sample air may build up to reduce membrane collection efficiency. Membranes with very large pores may be available. These types of membranes (e.g., membrane 63 of FIG. 5) not only may provide very high collection efficiency, but show no sign of fouling even when a 2 M NaCl solution is pumped through it and dry air flows on the outside. Such membranes may provide the basis for an attractive collector.

Transmission of an analyte through a nonporous (in a macroscale, all material is porous in a molecular scale) membrane such as Teflon® AF, other fluorocarbons or silicone, may involve dissolution of the analyte in the membrane matrix, and evaporation (and reactive capture) at the membrane liquid interface of tube 16. Because overall permeation rate may be regarded as a function of solubility in the matrix, there could be considerable selectivity imparted by the choice of the membrane. Most of the above-noted membranes may be nonpolar and thus allow significant transport of nonpolar NO₂ and O₃ molecules while the reverse permeation of highly polar water through the membrane (i.e., reagent evaporation) may occur at a much lower extent. While H₂O₂, O₃ and NO₂ may all react with luminol to produce light, by choosing a highly polar membrane, the measurement may become specific for H₂O₂. On the other hand, with a nonpolar membrane, the response to H₂O₂ may be essentially eliminated and if a suitable catalytic destruction agent, e.g., MnO₂, is incorporated in the sampling inlet 35, device 10 may respond specifically to NO₂ (and peroxyacylnitrates (PAN)).

The choice of the analytical reaction may be very important for the measurement by device 10 to be sensitive and selective. Further, the reaction may need to be reasonably fast at room temperature; otherwise, the necessary reaction time may become the determinant of the response time. Additionally, other desireable characteristics may include the use in device 10 of commercially available, inexpensive chemicals which may be used in low concentrations and pose a minimum risk of toxicity or other hazards.

The following table is a noncomprehensive list of gases that may be sensed with device 10. There may be a much larger range of gases that can be sensed with exquisite sensitivity and specificity if multiple reagent chemistry and stepped sequential reactions are added to device 10 in the form of a sequential injection analyzer (SIA) and an LED excited liquid core waveguide (LCW) based fluorescence detector. So with these additions to device 10, measurements of formaldehyde, peroxides, ammonia and other chemicals, may be made routinely at parts per trillion levels.

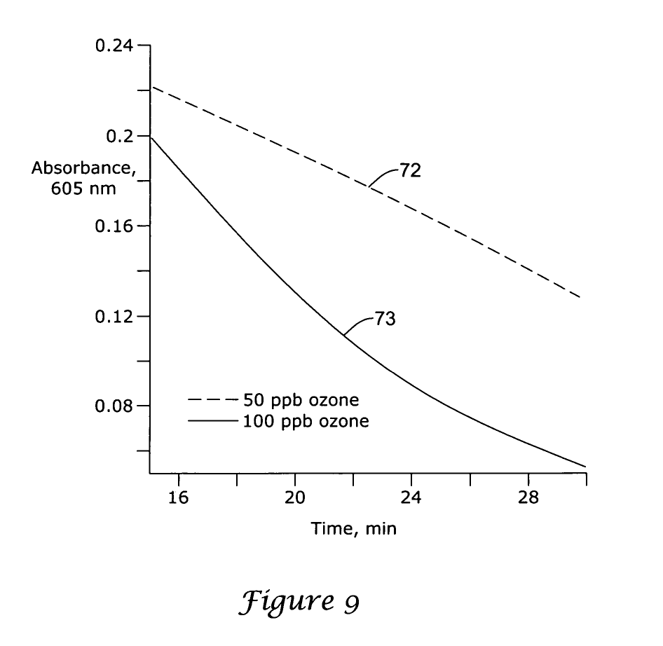

FIG. 9 shows the response time of a 5 cm long membrane tube 16 (membrane number 4 of FIG. 8) filled with 0.25 μM ITS to two different concentrations of ozone with no matrix modifier. FIG. 9 is a data slice of an experiment in the core of membrane tube 16 exposed to 50 and 100 ppb of ozone, at curves 72 and 73, respectively. It appears that the LOD would be better than 5 ppbv with an approximate integration time. Once the experiment or activity is optimized relative to the membrane, pathlength, reagent concentration, LED choice and electronics, one may expect one ppd LOD with an integration time of 5 minutes to be possible. Likewise, the data presented for NO₂ in FIG. 3, one may expect a very similar LOD, one ppb NO₂ with an integration time of 5 to 10 minutes to be possible.

In regard to interferences, ITS may be specific for ozone. The reaction of O₃, with ITS, is diffusion controlled, and as such, it is not expected that even sulfite from SO₂ dissolution will compete for the ozone. In any case, with a nonpolar membrane, there may be selective transport of O₃ over SO₂. There could possibly be some interference of SO₂ on the ITS-based ozone determination.

For the measurement of NO₂ by the G-S or similar reactions, there should be no response from any compound other than PAN or HONO, and no other compounds are known to interfere negatively either. NO should not interfere. The responses of a Teflon® AF based device 10 to NO₂ and HONO may be very close to each other but differences may exist such that using a device 10 with tubes 16 having different lengths and/or wall thicknesses, it is possible to determine both in a two-component mixture. If a pure fluorocarbon membrane (rather than an oxo-polymer like Teflon® AF) is chosen, the selectivity of NO₂ over HONO should increase. Realistically, HONO does not appear to pose a significant interference because its ambient conditions may be much lower than that of NO₂.

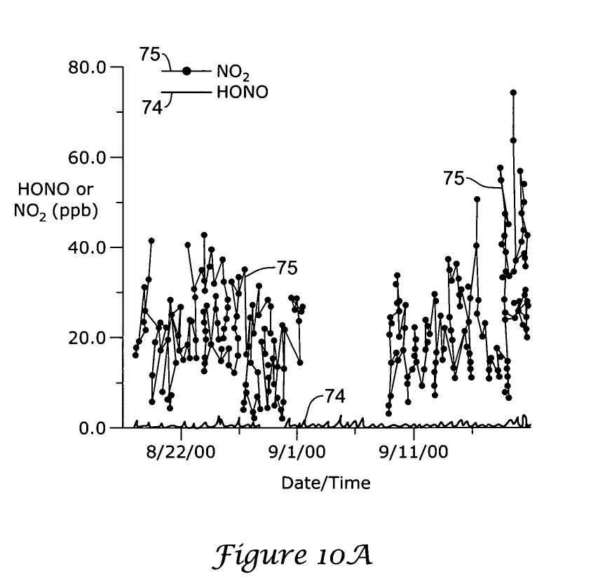

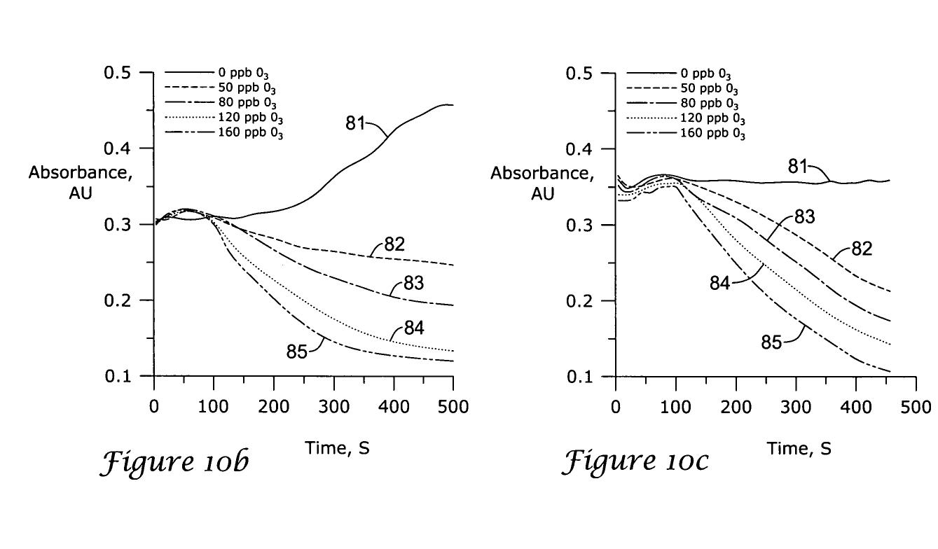

FIG. 10a shows data from a continuous wet denuder—ion chromatography measurements 74 of HONO (which may tend to somewhat overestimate HONO concentrations due to artifact HONO production from the NO₂—H₂O reaction) along with simultaneous measurements 75 of NO₂ by a gas phase CL based FRM NO₂ instrument by the Texas Commission on Environmental Quality. Similar other measurements for ambient air in many other locations tend to also indicate that NO₂ may always be present in many times larger concentrations than HONO. The only known exception may be in the vicinity of open flame sources.

FIGS. 10a and 10c are graphs showing ozone absorbance versus time for various amounts of ozone, without and with an inert dye added to the reagent, respectively. Water evaporation may cause the reagent concentration to increase, especially when a small tube (5 cm with a 0.6 mm inside diameter) is used, as noted in FIG. 10b. It is compensated for by adding an inert dye which adsorbs at the reference wavelength. Lines 81, 82, 83, 84 and 85 represent 0 ppb, 50 ppb, 80 ppb, 120 ppb and 160 ppb of O₃, respectively in the graphs of FIGS. 10b and 10c.

PAN should not hydrolyze to nitrite as rapidly in an acidic solution (such as that of a G-S reagent) as it does in an alkaline solution. Nevertheless, bubbling PAN through a bubbler containing a G-S reagent may result in some color. PAN typically may be present only at a small fraction of the NO₂ concentration. PAN is a much larger molecule than NO₂ and diffusive transport through the polymer should be accordingly slower. One may want to characterize the response from HONO and PAN relative to NO₂.

Device may be deployed practically anywhere. If deployed indoors, one would locate the reagent reservoir 11 at some height above tube 16 and waste bottle 15. Power may be provided by battery or a power adapter connected to a wall socket plug. If utilized outside, an internal battery or a DC-DC converter to an automotive battery or the like may be used. The power requirement may be rather small and device 10 may be operated for an extended period of time with a typical auto battery.

A base sensor unit 16 of device 10 may be connected to a miniature electronics box containing a microprocessor and a flashcard RAM with a rudimentary display for a readout of data as it is being collected and which will let subsequent data to be dumped into a PC. Another hookup may involve a mini-interface box connected to a laptop computer. Just as intra-venous fluid feedbacks are held in a hospital, device 10 may be deployed with a stand having hooks at several levels to hold reagent reservoir 11 and waste container 15. Feed reagent reservoir 11 may hang from one hook and reagent 12 waste reservoir 15 may be hung from a lower hook or hooks. Some components may need to b protected from ambient environment elements and a liquid reagent would not be workable at temperatures below freezing. Device behavior may be characterized as a function of environmental variables.

No special sitting needs for device 10 should be required. There should be no presampling or post sampling needs. When a laptop system is used, the environment should be adequate to use the device for an extended period. The laptop software may display data in a moving strip chart fashion using whatever integration period that the user has initially specified. However, the software may reprocess the acquired data using different integration times and/or constants if dictated to do so postsampling. The instrument may only display data in terms of a calibration constant that is provided to it at the time sampling is begun. If at the end of a month-long sampling campaign, the post-sampling calibration indicates that the calibration has shifted, then the software may readily reprocess the data based on the new calibration, an average of the new and old calibrations, and/or a linearly occurring change between the new and old calibrations.

Calibration may be provided for device 10. For instance, a permeation tube based calibrator may be used for NO₂, and a UV-lamp based calibration for ozone. Other calibrators may be used.

For ozone, an O₃ generator may be based on a miniature UV lamp. A generator may operate at a known output of analyte gas. The housing may contain a photodiode to monitor that the light source is constant.

One may study the generated ozone concentration as a function of the mass flow rate and ambient pressure. These factors may be considered in generating and specifying a calibration standard. Device may be initially calibrated with a known ozone concentration in a laboratory setting. To begin, the instrument may be chipped with a manufacturer's calibration. There may be nothing to be poisoned or soiled in a nonporous membrane based device 10. It should be trivial to awash out the interior of the jacket and the exterior of the membrane at the end of a month or so.

Reagent 12 replacement needs for device 10 may depend on the concentration of the analyte actually encountered, requiring more frequent replacement when the upper or lower absorbance limit is reached within shorter times due to high levels of O₃ or NO₂.

FIG. 1 shows how a business-card sized monitor or device 10 may be designed to hold reagent 12 in a slightly pressurized reservoir 11, from which the reagent may be metered (via an embedded flow sensor, not shown) into the optical path as needed and then moved to waste reservoir 15. Light sources 17 and 19 and detector 23 may or may not be part of a disposable and sealed reagent card. This approach may be used for a micro fabricated O₃ and/or NO₂ monitor 10.

A computer, data acquisition/control interface and software may provide the functions of instrument control, signal recording, data processing and function reporting. Programmed instrument control may utilize the processing and timing function of the computer to operate light sources 17, 18, valve 14, detector 23, and other controllable items of device 10. Important signals generated by device 10 may be incorporated after digitization, and then recorded for inspection, diagnostic, backup and/or archival purposes. Automatic data processing of the signals received may provide easier access to and interpretation of the monitoring data operated by device 10. Data processing coupled with programmatic feedback mechanisms may also enhance the efficiency and effectiveness of the control functions provided by the software. Data received and calculated may be available via several interface methods to enable proper monitoring, maintenance and regulation of device 10.

The electronics may incorporate an analog to digital converter, a microcontroller and a FLASH memory. An interface between the computer and device 10 may be a data and acquisition control board (DAQ). The interface may provide TTL level digital output signals used to control device 10, sources 17, 18, and valve 14. Also, it may accept digital and analog signals from detector 23 and other items for data recording and feedback control purposes.

The computer interface may allow timed control and storage for periods as short as 0.1 second or as long as several months. Typical time intervals may be from seconds to minutes for temporal resolution or data storage. Valve 14 may be switched via a digital output relayed through a MOSFET switch and may be used to control the flow of fresh reagent 12, into device 10. Light sources 17 and 18 used for photometric measurement of analyte in tube 16, 16 may also be controlled by the digital output. Primary analyte determination LED 17 may be pulsed on to gather absorbance information from the sample cell (Vₛ). Reference LED 18 at a non-absorbing wavelength, also under program control, may also be pulsed on end off to provide a reference signal (V_{R}) for canceling electronic and mechanical noise in the data signal. When both LEDs 17 and 18 are off, a blank signal (V_{B}) may be recorded. The absorbance may be calculated from log[(V_{R}-V_{B})/(V₅-V_{B})].

Signals from various sensor devices 10 may be collected via the analog inputs of the interface board. The interface may automatically digitize voltage signals received after which may be compressed. In the event that the normal operating parameters of a device 10 are exceeded and the feedback control mechanisms are unable to restore proper device 10 operation, the software may initiate an alarm condition and if desired, dial any designated number via a modem line. The software may also annotate improper or suspect device 10 functioning along the recorded signal and processed data, so that operator inspection of the records might still recover useful data from marginal signals. Recorded device parameters during an alarm condition may also provide significant diagnostic information leading to proper and timely corrective action.

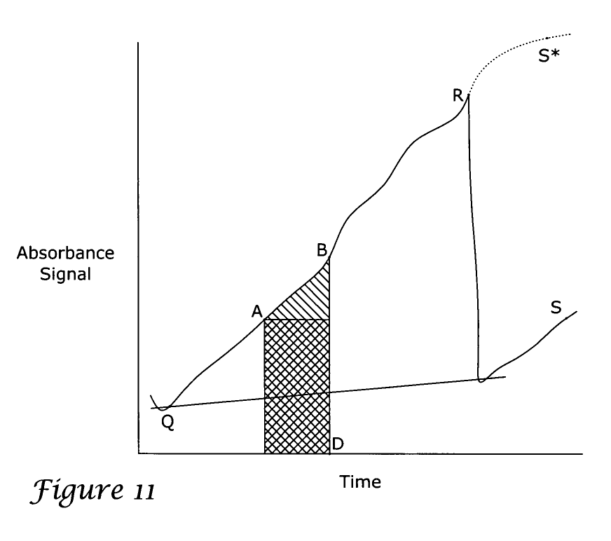

During standard operation, the computer may record and analyze signals when placed in the RUN mode. The RUN mode may be entered around the repetition of a logical cycle based primarily on the requirement for periodic replacement of analyte solution in the detector chamber. After the detector chamber is refreshed (e.g., at Q in FIG. 11), a steady accumulation of the analyte reaction product in detector or device 10 chamber 16 may generate a continuously increasing voltage signal from the detector rising to R, as shown in FIG. 11. FIG. 11 illustrates a simulated signal versus time for various operational modes of sensor 10.

If continued to go on, the voltage may rise/fall until a saturated condition occurs as shown in a hypothetical dashed line portion in S*. To prevent device 10 operation in this saturated region, a maximum/minimum signal cutoff point may be established during design of device 10 and calibration to force reagent 12 replacement. In this example, the reagent 12 refill setpoint is at R in FIG. 11. At this point, a signal may be sent to valve 14 to open so that reagent 12 is refilled and the detector 23 signal returns more or less to its original position. A small upward drift is deliberately shown in this example and then again it begins to rise, e.g., to S. Periodic replacement of reagent 12 in detector compartment 16, 16 may be desireable even when the maximum signal cutoff point has not been reached. Thus, the algorithm may force a refill cycle when either the maximum (minimum) signal or maximum reagent 12 lifetime occurs. These two parameters may be established during the instrument design stage, and be adjusted during calibration and operation, as necessary.

During the sample detection portion of cycle (Q-R), the rate of change may be proportional to the amount of analyte collected, and this may provide a measure of the atmospheric concentration of analyte. The average analyte concentration between points A and B may be computed by taking the area under the curve A to B above a baseline relative to point A. The area under the curve above the x-axis may consist of the entire hatched area. Removal of the crosshateched area (rectangle with A and D opposite corners), may leave the single hatched area, which may be valid for an ideal case where the baseline has no slope. This value may be reported real-time as a preliminary indication of the atmospheric concentration of the analyte. At the completion of a full sampling cycle, compensation (corresponding to the small shaded gray wedge) for any change in the absolute baseline condition may be made.

The process of device 10 control, signal recording, data processing and real time reporting/annunciation may be handled simultaneously by nearly any current version of a laptop computer and a data acquisition and control board. The software may be modular in design to permit efficient reuse in instruments of similar function but for different analytes. Most software parameters may be user configurable to increase usability. The modularity and initial design of the software may permit easy integration of several units to permit economical operation of multiple instruments. Several analytical methods may be integrated into a single device 10 and thus permit simultaneous determination of multiple analytes with a modest investment.

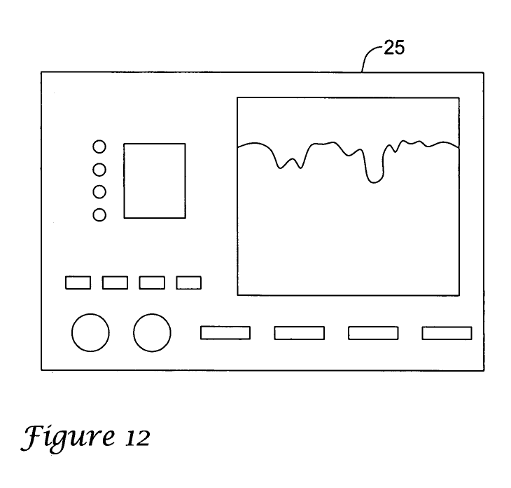

A typical screen from software that controls an H₂S device 10, may display the concentrations real time in a scroll chart fashion as shown in of display 25 in FIG. 12. The screen may also show the status of different functions. Display 25 may be scrolled back in time.

Although the invention has been described with respect to at least one illustrative embodiment, many variations and modifications will become apparent to those skilled in the art upon reading the present specification It is therefore the intention that the appended claims be interpreted as broadly as possible in view of the prior art to include all such variations and modifications.

What is claimed is:

1. A sensor comprising:
an enclosure having an input and an output;
a light source proximate to the enclosure;
a light detector proximate to the enclosure; and
wherein the enclosure is capable of containing a first fluid.

2. The sensor of claim 1, wherein the enclosure comprises a permeable wall.

3. The sensor of claim 2, wherein the permeable wall can permit entry of a second fluid into the enclosure.

4. The sensor of claim 3, wherein:
the first fluid is a reagent; and
the second fluid is an analyte.

5. The sensor of claim 3, further comprising a processor connected to the light detector.

6. The sensor of claim 5, further comprising an indicator connected to the processor.

7. The sensor of claim 6, further comprising a container connected to the input of the enclosure.

8. The sensor of claim 7, further comprising a valve connected to the output of the enclosure.

9. The sensor of claim 8, further comprising a second container connected to the output of the enclosure.

10. The sensor of claim 9, further comprising a second light source proximate to the enclosure.

11. The sensor of claim 10, wherein:
the light source has a first wavelength; and
the second light source has a second wavelength.

12. The sensor of claim 11, wherein:
the first fluid is a reagent; and
the second fluid is an analyte.

13. A fluid sensor comprising:
a tube comprising a membrane wall;
a reagent supply container connected to a first end of the tube;
a reagent disposal container connected to a second end of the tube;
a first light source having a first wavelength proximate to the second end of the tube;
a second light source having a second wavelength proximate to the second end of the tube; and
a light detector proximate to the first end of the tube.

14. The sensor of the claim 13, further comprising control electronics connected to the first and second light sources, and to the light detector.

15. The sensor of claim 14, wherein a fluid to be tested may flow proximate to the tube.

16. The sensor of claim 15, wherein the membrane is permeable for permitting an entry of an analyte from the fluid into the tube.

17. A sensor comprising:
a first container;
a tube, having a porous wall, connected to the first container; and
a light source proximate to the tube.

18. The sensor of claim 17, further comprising a reagent in the tube.

19. The sensor of claim 18, further comprising a valve connected to one end of the tube.

20. The sensor of claim 19, further comprising a light detector proximate to the tube.

21. The sensor of claim 20, further comprising a second light source proximate to the tube.

22. The sensor of claim 20, further comprising a second container connected to the valve.

23. The sensor of claim 22, further comprising a flow sensor proximate to the tube.

24. The sensor of claim 23, wherein the sensor is integrated into a phased heater sensing system.

25. The sensor of claim 24, wherein the sensor is integrated into a cytometer system.

26. A sensing means comprising:
means for the holding a fluid;
means for providing a fluid to the means for holding the fluid;
means for controlling a flow of a fluid into the means for holding a fluid;
means for illuminating a fluid in the means for holding a fluid; and
means for detecting light from the means for illuminating a fluid via the means for holding a fluid; and
wherein the means for holding a fluid permits analyte to enter the means for holding a fluid.

27. The sensing means of claim 26, wherein the fluid is a reagent.

28. The sensing means of claim 27, wherein the means for illuminating emanates light at two different wavelengths.

29. The sensing means of claim 28, further comprising a means for processing connected to the means for controlling a flow of a fluid, the means for illuminating, and the means for detecting light.

30. The sensing means of claim 29, further comprising a means for providing information connected to the means for processing.

31. A method for sensing, comprising:
placing a reagent into an enclosure;
subjecting the enclosure to an environment containing analyte so that the analyte mixes with the reagent;
illuminating the reagent; and
detecting light from the reagent.

32. The method of claim 31, further comprising converting the light into electrical signals.

33. The method of claim 32, further comprising processing the electrical signals into information about the analyte.

34. The method of claim 33, further comprising replenishing the reagent in the enclosure.

35. The method of claim 34, further comprising repeating the method of claims 31-34.

36. The method to claim 35, wherein the enclosure has a membrane wall capable of permeation by the analyte.

37. The method of claim 36, wherein the membrane is capable of containing the reagent in the enclosure.

38. A sensor comprising:
an enclosure having an input and an output;
a light source proximate to the enclosure;
a light detector proximate to the enclosure; and
wherein the enclosure is capable of containing a fluid.

39. The sensor of claim 38, wherein the enclosure comprises a membrane.

40. The sensor of claim 39, wherein the membrane can permit entry of analyte into the enclosure.

41. The sensor of claim 40, wherein the membrane can permit entry of reagent into the enclosure.

42. The sensor of claim 41, further comprising a processor connected to the light detector.

43. The sensor of claim 42, further comprising an indicator connected to the processor.

44. The sensor of claim 43, further comprising a container connected to the input of the enclosure.

45. The sensor of claim 44, further comprising a valve connected to the output of the enclosure.

46. The sensor of claim 45, further comprising a second container connected to the output of the enclosure.

47. The sensor of claim 46, further comprising a second light source proximate to the enclosure.

48. The sensor of claim 47, wherein:
the light source has a first wavelength; and
the second light source has a second wavelength.

49. The sensor of claim 48, further comprising a flow sensor in the enclosure.

50. The sensor of claim 48, wherein each of the light source and the second light source may a laser type of light source.
